(19) United States
(12) Patent Application Publication
(10) Pub. No.: US 2019/0381613 A1
(43) Pub. Date: Dec. 19, 2019

(54) MOBILE CNC MACHINING MACHINE

(71) Applicant: SIEMENS AKTIENGESELLSCHAFT, MÜNCHEN (DE)

(72) Inventors: Sebastian Potyka, HÜNXE (DE); Stefan Sellmann, Essen (DE); Felix Vogt, Oberhausen (DE); Jannik Lüpfert, Essen (DE)

(21) Appl. No.: 16/481,515

(22) PCT Filed: Mar. 15, 2017
(86) PCT No.: PCT/EP2017/056090

§ 371 Date: Jul. 29, 2019

(30) Foreign Application Priority Data
Jan. 31, 2017 (DE) 10 2017 201 497.0

(51) Int. Cl. B23Q 1/00; B23Q 1/01

(52) U.S. Cl. CPC B23Q 1/0054; B23Q 37/005; B23Q 1/015

(57) ABSTRACT

Provided is a mobile CNC machining machine which is designed to machine a rotor of a turbomachine, wherein the turbomachine is a rotor of a steam turbine, including an x-axis, a y-axis and a z-axis which are arranged perpendicular to one another, a baseplate, a stator which is arranged on the baseplate and is movable relative to the baseplate along the x-axis, and a tool module which is held on the stator and is movable along the y-axis and along the z-axis and is designed to accommodate a machining tool wherein, guided along a circular-arc-shaped convex guide disposed on the stator, the tool module is movable about a c-axis which extends parallel to the x-axis; in that the z-axis intersects the c-axis; and in that the y-axis extends tangentially to a circular path, of which the c-axis is the center point.

### CROSS-REFERENCE TO RELATED APPLICATIONS

This application claims priority to PCT Application No. PCT/EP2017/056090, having a filing date of Mar. 15, 2017, which is based on German Application No. 10 2017 201 497.0, having a filing date of Jan. 31, 2017, the entire contents both of which are hereby incorporated by reference.

### FIELD OF TECHNOLOGY

The following relates to a mobile CNC machine tool which is designed to machine a rotor of a continuous-flow machine, in particular to machine a rotor of a steam turbine, comprising an X axis, a Y axis, and a Z axis which are each arranged at right angles to one another, a bottom plate, a stand arranged on the bottom plate and capable of being displaced relative to the latter along the X axis, and a tool module which is held on the stand so that it can be displaced along the Y axis and along the Z axis and is designed for receiving a machining tool.

### BACKGROUND

Rotors of steam turbines of a power plant are subject to high mechanical and/or thermal loads during operation. Against this background, it is often necessary for the rotors to undergo mechanical machining as part of maintenance work. The grooves provided on a rotor to receive rotor blades are thus, for example, remachined using a milling tool.

When such a mechanical machining of a rotor is due, there is an option of disassembling the rotor and transporting it to a production facility in which a CNC machine tool suitable for performing the required machining is fixedly positioned. The transporting is, however, very time-intensive and entails a long downtime for the power plant and correspondingly high costs.

A further option is to mechanically machine the rotor on site in the power plant. To do this, a mobile CNC machine tool of the type mentioned at the beginning suitable for performing the required machining must be transported to the power plant and set up there, after which the disassembled rotor can be machined. Such a mobile CNC machine tool is disclosed, for example, in WO 2013/178377 A1. The CNC machine tool described here comprises a bottom plate in the form of a modularly structured machine bed on which are arranged a headstock with a headstock chuck, a tailstock with a tailstock chuck, at least two bearing blocks and at least one stand. The stand can be displaced along an axis which in the present case is designated as an X axis of the CNC machine tool, the axis extending in the longitudinal direction of the machine bed. A tool module is held on the stand so that it can be displaced in two directions at right angles to each other, designated in the present case as the Y axis and the Z axis. Accordingly, a machining tool held by the tool module can be displaced along the X, Y, and Z axis. In order to machine the rotor, it is disassembled and mounted on the bearing blocks between the headstock and the tailstock in such a way that it can be driven in rotation about a C axis of the CNC machine tool. The mechanical machining can now take place with the machining tool. The CNC machine tool described in WO 2013/178377 A1 is, however, very bulky and has a high dead weight, which is a disadvantage in terms of acquisition costs and transportation. Moreover, it takes up a very large amount of space which is not available in all power plants.

Starting from this known art, the object of embodiments of the present invention is to provide a mobile CNC machine tool of the type mentioned at the beginning with an alternative structure.

### SUMMARY

An aspect relates to a mobile CNC machine tool of the type mentioned at the beginning which is characterized in that the tool module is guided on a convex guide in the shape of an arc of a circle arranged on the stand, and can be displaced about a C axis which extends parallel to the X axis, in that the Z axis intersects the C axis, and in that the Y axis extends tangentially to a circular path which has the C axis as a center point. In this way, a new machine tool design is obtained which is distinguished from the known machine tool designs in particular in that there is no headstock or tailstock and hence the rotor to be machined is not held so that it can be driven in rotation about a C axis of the machine tool. Instead, in the CNC machine tool according to embodiments of the invention, the tool module which can be displaced along the X axis, the Y axis, and the Z axis can be positioned about the C axis along the convex guide in the shape of an arc of a circle arranged on the stand. This means that in particular the bottom plate and the machine bed can be designed so that they are very small, as a result of which a relatively very low dead weight of the CNC machine tool according to embodiments of the invention can be obtained, which has an influence in particular on the transportability and the associated costs. Moreover, the structure of the CNC machine tool according to embodiments of the invention can be very compact, which entails low acquisition costs.

According to embodiments of the present invention, the bottom plate has a plurality of leveling devices which are designed for orienting the bottom plate relative to a subsurface. Accordingly, the CNC machine tool according to embodiments of the invention can be set up without any problem on a wide range of subsurfaces and oriented relative to the subsurface and/or the workpiece to be machined.

A baseplate is fastened removably to the bottom plate using screws and centering pins, the baseplate being provided on its upper surface with linear guides for the displacement of the stand along the X axis. The removable arrangement is conducive to a modular structure of the CNC machine tool and to the associated good transportability. The centering is expedient for ensuring that the orientation of the CNC machine tool is not lost in the event of it being repositioned multiple times.

An intermediate plate on which the stand is fastened is guided on the linear guides, wherein the intermediate plate is fastened removably in particular using fastening screws and centering pins. The intermediate plate provides the stand with a removable interface for the displacement unit along the X axis.

A working platform, in particular one with an integrated switch cabinet, is advantageously fastened on the intermediate plate. In this way, a very compact structure of the CNC machine tool according to embodiments of the invention is obtained.

According to embodiments of the present invention, the stand is designed as a cast construction, which is advantageous for reducing vibrations.

The tool module can be displaced along the convex guide in the shape of an arc of a circle which is arranged on the stand, by a defined angle about the C axis. For example, in the case of a 90° degree of freedom, a peripheral machining of the rotor would be possible with only three rotations.

The tool module can advantageously be locked steplessly in the different angular positions. A blade foot receiving groove can thus in particular be machined by the tool module being oriented in a first step relative to the C axis, then being locked, and lastly machined by the tool unit being displaced along the X, Y, and Z axis.

According to embodiments of the present invention, the tool module is a milling module which is designed to drive a milling tool in rotation about the Z axis.

The embodiments moreover provide a method for mechanically machining a rotor of a continuous-flow machine using a CNC machine tool of the above-described type according to embodiments of the invention, wherein the method has the steps: a) jacking the rotor to be machined up on support blocks; b) constructing the machine tool next to the jacked-up rotor in such a way that the X axis of the machine tool extends parallel to the longitudinal axis of the rotor, and that the C axis of the machine tool coincides with the longitudinal axis of the rotor; c) machining a first peripheral part region of the rotor using the machine tool; d) rotating the rotor about its longitudinal axis by a predetermined angle, for example with the assistance of an indoor crane; e) machining a further peripheral part region of the rotor using the machine tool; and 0 repeating steps d) and e) until the whole peripheral region of the rotor has been machined.

### BRIEF DESCRIPTION

Some of the embodiments will be described in detail, with references to the following Figures, wherein like designations denote like members, wherein:

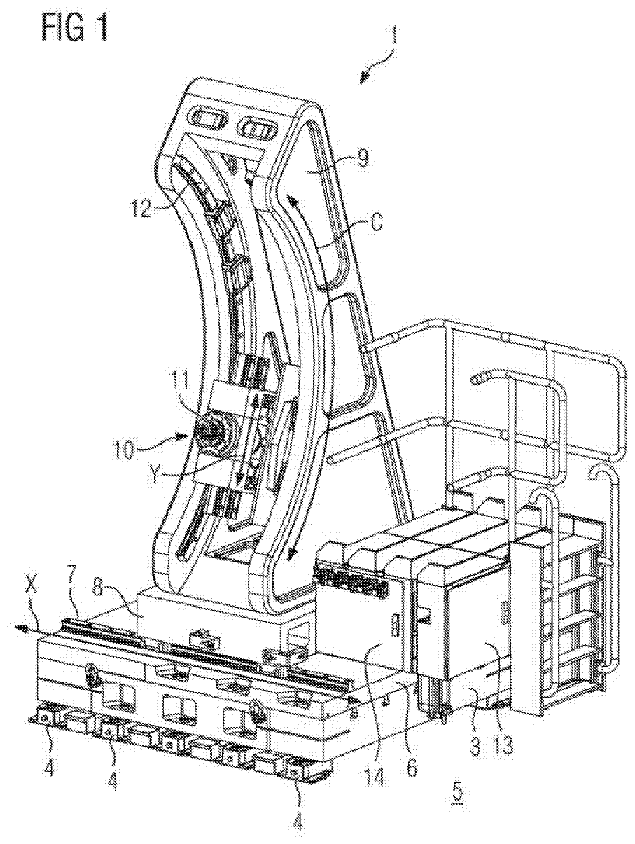

FIG. 1 is a schematic perspective view of a mobile CNC machine tool according to embodiments of the present invention;

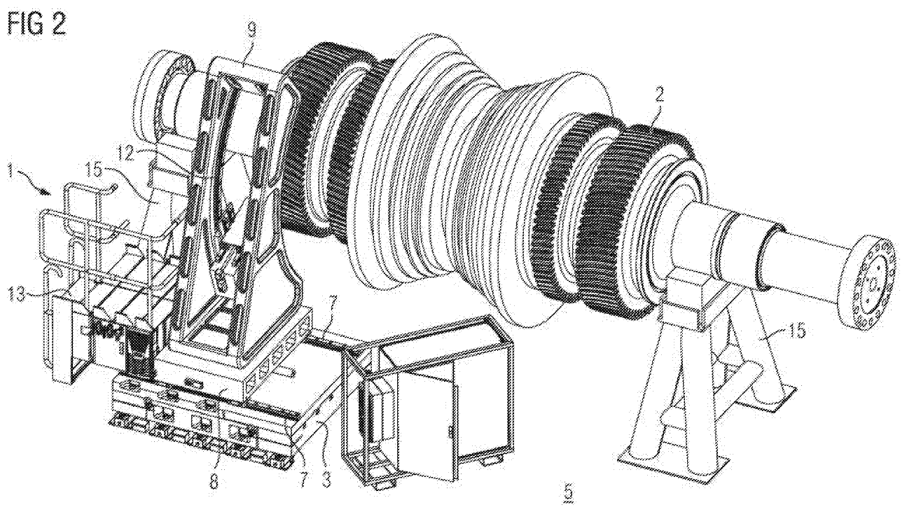

FIG. 2 is a schematic perspective view of the CNC machine tool shown in FIG. 1 during the machining of a rotor; and

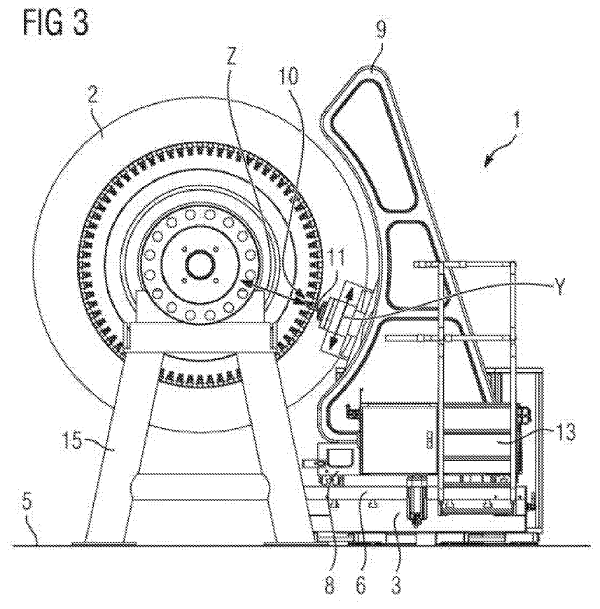

FIG. 3 is a side view of the arrangement shown in FIG. 2.

### DETAILED DESCRIPTION

The mobile CNC machine tool 1 serves to machine a rotor 2 of a continuous-flow machine, such as, for example, a rotor of a steam turbine. It has a modular structure, the size of the modules being chosen such that, in the disassembled state, the CNC machine tool can be transported in conventional freight containers and is accordingly mobile. The CNC machine tool 1 comprises a bottom plate 3 with a plurality of leveling devices 4 which are designed for orienting the bottom plate 3 relative to a subsurface 5. A baseplate 6, which is provided on its top side with linear guides 7 extending in the direction of an X axis of the CNC machine tool 1, is fastened removably to the bottom plate 3 using screws and centering pins (not shown in detail). An intermediate plate 8, on which a stand 9 is fastened, is guided on the linear guides 7, wherein the intermediate plate 8 is fastened removably using fastening screws and centering pins (likewise not shown in detail). A tool module 10 is held on the stand 9 so that it can be displaced along a Y axis and along a Z axis of the CNC machine tool 1. In the present case, the tool module 10 is designed as a milling module and designed for receiving a machining tool 11 in the form of a milling cutter and driving it in rotation about the Z axis. The tool module 10 which can be displaced along the Y and Z axes is held on the stand 9 on a convex guide 12 in the shape of an arc of a circle and can thus be displaced, in pivoting fashion about a C axis of the CNC machine tool 1, along a circular line which extends parallel to the X axis and intersects with the Z axis. The Y axis correspondingly extends tangentially to a circular path which has the C axis as its center point. The tool module 10 can be locked steplessly in the shape of a circular line about the C axis in the different angular positions. The CNC machine tool 1 moreover has a working platform 13 with an integrated switch cabinet 14 which, in the present case, is fastened on the intermediate plate 8 and from which the CNC machine tool 1 can be controlled by an operator.

The X axis, the Y axis, and the Z axis are each arranged at right angles to one another. The X axis is here fixed, whilst the Y axis and the Z axis vary depending on the pivoted position of the tool module 10 about the C axis.

In order to machine a rotor 2, as shown in FIGS. 2 and 3, the latter is first disassembled and, after the rotor blades held on it have been removed, arranged on support blocks 15. The CNC machine tool 1 is then constructed next to the jacked-up rotor 2 in such a way that the X axis of the CNC machine tool 1 extends parallel to the longitudinal axis L of the rotor 2, and that the C axis of the CNC machine tool 1 coincides with the longitudinal axis L of the rotor 2. The rotor 2 can then be mechanically machined over a first peripheral part region using the machining tool 11. In a further step, the rotor 2 is rotated on the support blocks 15 by a predetermined angle about its longitudinal axis L, which can be effected, for example, with the assistance of an indoor crane or the like. The mechanical machining of a further peripheral part region of the rotor 2 then follows. The last two steps are then repeated until the whole peripheral region has been machined. If further regions are then required to be machined, the CNC machine tool can be repositioned in the direction of the X axis if this is necessary for machining further turbine stages.

An essential advantage of the above-described CNC machine tool 1 consists in the fact that the tool module 10 can be displaced about the C axis along the convex guide 12 in the shape of an arc of a circle arranged on the stand 10. It is thus not absolutely necessary to mount the rotor so that it can be driven in rotation, which means that in particular the bottom plate can be relatively small in design. This entails a low dead weight of the CNC machine tool 1 and a small space requirement, which in particular has a positive influence on the acquisition costs and the transportability of the CNC machine tool 1.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCE SYMBOLS

1 CNC machine tool

2 rotor

3 bottom plate

4 leveling device

5 subsurface

6 baseplate

7 linear guide

8 intermediate plate

9 stand

10 tool module

11 machining tool

12 guide

13 working platform

14 switch cabinet

15 support block

L longitudinal axis

1. A mobile CNC machine tool designed to machine a rotor of a continuous-flow machine, wherein the continuous flow machine is a rotor of a steam turbine, comprising an X axis, a Y axis, and a Z axis which are each arranged at right angles to one another, a bottom plate, a stand arranged on the bottom plate and capable of being displaced relative to the latter along the X axis, and a tool module which is held on the stand so that it can be displaced along the Y axis and along the Z axis and is designed for receiving a machining tool, wherein the tool module is guided on a convex guide in the shape of an arc of a circle arranged on the stand, and can be displaced about a C axis which extends parallel to the X axis, in that the Z axis intersects the C axis, and in that the Y axis extends tangentially to a circular path which has the C axis as a center point.

2. The CNC machine tool as claimed in claim 1, wherein the bottom plate has a plurality of leveling devices which are designed for orienting the bottom plate relative to a subsurface.

3. The CNC machine tool as claimed in claim 1, wherein a baseplate is fastened removably to the bottom plate using screws and centering pins, the baseplate being provided on its upper surface with linear guides for the displacement of the stand along the X axis.

4. The CNC machine tool as claimed in claim 3, wherein an intermediate plate on which the stand is fastened is guided on the linear guides, wherein the intermediate plate is fastened removably in particular using fastening screws and centering pins.

5. The CNC machine tool as claimed in claim 4, wherein a working platform, having an integrated switch cabinet, is fastened on the intermediate plate.

6. The CNC machine tool as claimed claim 1, wherein the tool module can be displaced along the convex guide in the shape of an arc of a circle which is arranged on the stand, by a defined angle about the C axis.

7. The CNC machine tool as claimed in claim 1, wherein the tool module can be locked steplessly in the different angular positions.

8. The CNC machine tool as claimed in claim 1, wherein the tool module is a milling module which is designed to drive a milling tool in rotation about the Z axis.

9. A method for mechanically machining a rotor of a continuous-flow machine using a CNC machine tool as claimed in claim 1, which has the steps: a) jacking the rotor to be machined up on support blocks; b) constructing the CNC machine tool next to the jacked-up rotor in such a way that the X axis of the CNC machine tool extends parallel to the longitudinal axis of the rotor, and that the C axis of the CNC machine tool coincides with the longitudinal axis of the rotor; c) machining a first peripheral part region of the rotor using the CNC machine tool; d) rotating the rotor about its longitudinal axis by a predetermined angle; e) machining a further peripheral part region of the rotor using the CNC machine tool; and f) repeating steps d) and e) until the whole peripheral region of the rotor has been machined.
